(19) United States
(12) Patent Application Publication
(10) Pub. No.: US 2014/0000217 A1
(43) Pub. Date: Jan. 2, 2014

(54) Cutter, Packaging Apparatus and Method of Cutting a Film

(71) Applicant: Cryovac, Inc., Duncan, SC (US)

(72) Inventor: Andrea Granili, Lainate (IT)

(73) Assignee: Cryovac, Inc., Duncan, SC (US)

(21) Appl. No.: 13/679,202

(22) Filed: Nov. 16, 2012

(30) Foreign Application Priority Data
Nov. 17, 2011 (EP) EP11189494

(51) Int. Cl. B65B 61/00; B26D 1/00; B65B 51/10

(52) U.S. Cl. CPC B65B 61/005; B65B 51/10; B26D 1/0006
USPC 53/329.2; 83/837; 83/13

(57) ABSTRACT

According to the invention, there is provided a cutter for a packaging apparatus. The cutter forms a shape. The cutter comprises at least one blade. Each blade comprises a plurality of first teeth and a plurality of second teeth. The first teeth are longer than the second teeth such that in use the first teeth contact a surface to be cut before the second teeth.

### TECHNICAL FIELD

The present invention relates to a cutter, a packaging apparatus comprising a cutter and a method of cutting a film. Optionally, the packaging apparatus comprises a tray lidding machine. The cutter is used to cut a film before or after the film is sealed to a tray.

### BACKGROUND ART

A packaging apparatus may be used to package a food product. The food product may be packaged in a tray with a lidding film forming a lid. A machine such as a tray lidding machine may be used to seal the lidding film onto the flange of the tray to form the film lid. A blade is used to cut a portion of a supply of lidding film to size, thereby to form the film lid.

The blade can be used to cut the lidding film either before or after the film is sealed onto the tray. During the cutting process, it is desirable that the blade cuts completely through the film at the first attempt. The blade may be serrated, with a series of triangular teeth having pointed tips. The blade can cut a portion of the film that fits the tray.

An aim of the present invention is to provide a serrated blade, and a packaging apparatus comprising a serrated blade. Another aim is to provide a method of cutting a film.

### DISCLOSURE OF THE INVENTION

According to the invention, there is provided a cutter for a packaging apparatus, the cutter forming a shape and comprising at least one blade, each blade comprising a plurality of first teeth and a plurality of second teeth, wherein the first teeth are longer than the second teeth such that in use the first teeth contact a surface to be cut before the second teeth.

Accordingly, the present invention provides a cutter that can cut through a surface to be cut in an efficient way. In particular, the cutter reduces stretching of the surface to be cut during a cutting operation. The less the surface stretches, the more complete the cut. In the context of tray lidding, the movement of the cutter is limited by the presence of the tray. The component that holds the cutter cannot move beyond the tray itself. The cutter of the present invention is required to move a lesser distance through the surface so as to complete the cut. As a result, the cut has a more desirable aesthetic appearance due to a reduced stretching of the material.

Optionally, the first teeth are interspersed with second teeth of the plurality of second teeth.

Accordingly, it is possible to avoid applying uniform pressure along the cutting perimeter of the surface to be cut. This reduces elongation of the surface to be cut which would otherwise hinder the cutting process.

Optionally, the cutter forms a substantially closed shape.

Accordingly, the cutter forms a die cut such that a lid can be cut to the desired shape from a portion of film in a single cut.

Optionally, the first teeth are longer than the second teeth by a distance within the range of from about 0.5 mm to about 1.0 mm.

Optionally, the first teeth are longer than the second teeth by a factor within the range of from about 1.00 to about 1.50.

Accordingly, the difference in teeth length is sufficiently great that the pressure applied along the cutting perimeter is sufficiently non-uniform so as to prevent undesirable stretching of the surface to be cut during the cutting operation. Furthermore, the difference in length between the teeth is sufficiently small that the blade is required to move a relatively small distance relative to the surface to be cut in order to perform the cutting operation. This improves the cleanness of the cut, thereby improving its aesthetic appearance.

Optionally, the first teeth are arranged along the blade at an average interval within the range of from about 5 mm to about 10 mm.

Accordingly, the distance between the first teeth is sufficiently great so as to reduce the pressure applied on the surface to be cut. This reduces the stretching of the surface during the cutting operation. The distance between the first teeth is sufficiently small such that the first teeth can penetrate the surface to be cut so as to perform the cutting operation effectively.

Optionally, the at least one blade comprises a substantially equal number of first teeth and second teeth; or

the at least one blade comprises about three times the number of second teeth as first teeth.

Accordingly, the ratio of first teeth to second teeth can be chosen so as to minimize stretching of a film to be cut during a cutting operation.

Optionally, the plurality of second teeth comprises at least two sets of teeth that have different lengths such that in use the two sets of teeth contact a surface to be cut at different times.

Accordingly, the cutter comprises teeth of three different lengths such that during a cutting operation the first teeth contact the surface to be cut first. The first teeth start penetrating the surface. Then, on a second step, the longer of the two sets of second teeth continue the cutting of the surface. Then, on a third step, the shorter of the two sets of second teeth complete the cutting of the surface in an efficient way.

Optionally, each of the first teeth and/or each of the second teeth forms a sharp point at its tip having an angle, in the plane of the blade, within the range of from about 50 degrees to about 60 degrees.

Accordingly, the teeth can penetrate the surface to be cut while reducing the undesirable stretching of the surface during the cutting operation. Furthermore, the first teeth can, during the penetration of the surface, create a slit that is sufficiently long as to aid the completion of the cutting operation during the second and optionally third cutting steps.

Optionally, the thickness of each blade tapers towards the tips of the first teeth and/or towards the tips of the second teeth.

Accordingly, the sharpness of the blade can be improved. The blade may have sharp singular points at which it comes into contact with a surface to be cut. This helps penetration of the surface by the blade.

According to the invention, there is provided a packaging apparatus comprising the serrated blade of the present invention.

Accordingly, the cutter can be used to perform clean cuts in packaging processes.

Optionally, the packaging apparatus comprises an actuator configured to move the blade in a cutting operation, wherein the packaging apparatus is configured such that the actuator moves the cutter by a maximum distance within the range of from about 5 mm to about 15 mm.

Accordingly, the cutter may be moved by a sufficient distance so as to perform a complete cut of the surface to be cut. Furthermore, the movement of the cutter relative to the surface to be cut is limited such that the aesthetic appearance of the completed cut is improved.

Optionally, the packaging apparatus comprises a sealer configured to seal a film to a tray, wherein optionally the packaging apparatus is configured such that in a packaging operation, the film is sealed to the tray before the film is cut by the cutter.

Alternatively the packaging apparatus is configured such that in a packaging operation, the film is sealed to the tray after the film is cut by the cutter

Accordingly, the cutter can be used in the context of a packaging apparatus that applies film lids to trays.

Optionally, the sealer is configured to heat to a temperature within the range of from about 100 degrees Celsius to about 150 degrees Celsius so as to seal the film to the tray.

Accordingly, the cutter can be used to efficiently cut a film that has undergone heating. This is significant because when a film is heated, it can become even more stretchable than normal. As such, a heated film is more susceptible to undergo undesirable elongation and/or stretching during a cutting operation. Hence, a heated film can be more difficult to cut than a non-heated film. The cutter of the present invention can cut thin and stretchable films even after they have undergone heating.

Optionally, the packaging apparatus comprises a film dispenser configured to dispense film that has a thickness of less than about 30 micrometers and/or a Young's modulus of less than about 100,000 MPa, wherein the packaging apparatus is configured such that the serrated cutter cuts the film.

Accordingly, the blade of the present invention can be used to efficiently cut through a film that is particularly elastic.

According to the invention, there is provided a method of cutting a film comprising the steps of:

providing a cutter forming a shape and comprising at least one blade, each blade comprising a plurality of first teeth and a plurality of second teeth, wherein the first teeth are longer than the second teeth; and

cutting the film with the cutter such that the first teeth contact the film before the second teeth.

Optionally, the second teeth start penetrating the film before the film is completely cut.

### BRIEF DESCRIPTION OF THE DRAWINGS

FIG. 1 depicts a serrated blade according to an embodiment of the present invention;

FIG. 2 depicts a plan view of a serrated blade according to an embodiment of the present invention;

FIG. 3 depicts a serrated blade according to an embodiment of the invention;

FIG. 4 depicts a cross-sectional view of a portion of a serrated blade according to an embodiment of the present invention;

FIG. 5 depicts a serrated blade according to an embodiment of the present invention;

FIG. 6 depicts a packaging apparatus according to an embodiment of the present invention;

FIG. 7 depicts a part of a packaging apparatus according to an embodiment of the present invention;

FIG. 8 depicts a part of a packaging apparatus according to an embodiment of the present invention;

FIG. 9 depicts a serrated blade according to an embodiment of the present invention;

FIG. 10 depicts a plan view of a serrated blade according to an embodiment of the present invention;

FIG. 11 depicts a plan view of a serrated blade according to an embodiment of the present invention; and

FIG. 12 depicts a plan view of a serrated blade according to an embodiment of the present invention.

### MODE FOR THE INVENTION

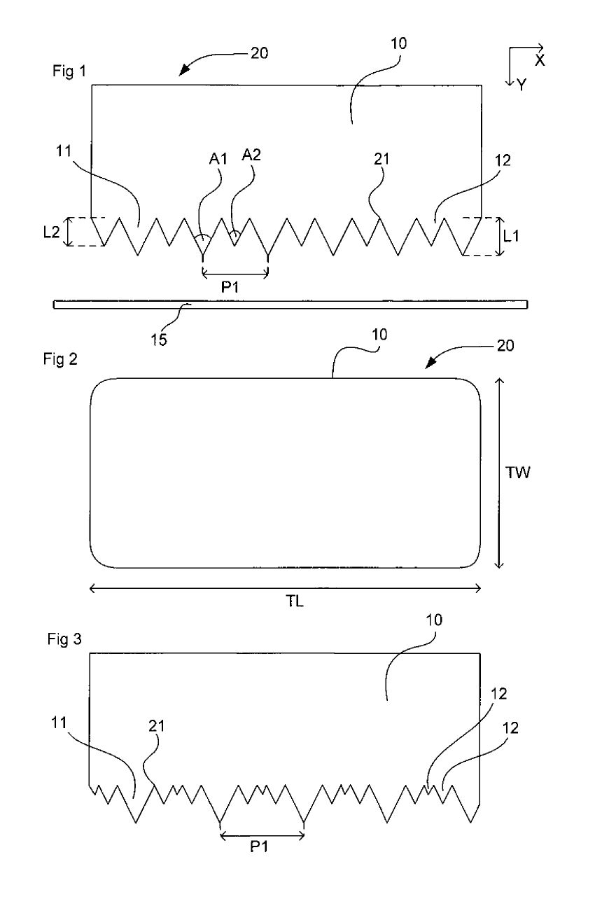

FIG. 1 depicts a blade 10 of a cutter 20 according to an embodiment of the present invention. The cutter 20 may be for a packaging apparatus 1. The cutter 20 may form a shape. The cutter 20 comprises at least one blade 10. Each blade 10 may comprise a plurality of first teeth 11 and a plurality of second teeth 12. The first teeth 11 may be longer than the second teeth 12 such that in use the first teeth 11 contact a surface 15 to be cut before the second teeth 12.

The shape formed by the cutter 20 is not particularly limited. A shape is two dimensional. Hence a single straight line is not a shape, but an L-shape is a shape, for example.

As depicted in FIG. 2, in an embodiment the cutter 20 forms a closed shape. In a closed shape, there are no gaps in the cutter 20 when viewed in plan. As depicted in FIG. 2, the cutter 20 may comprise a single blade 10. The single blade 10 may form a closed shape.

However, the shape formed by the cutter 20 is not necessarily absolutely closed. The shape may comprise one or more gaps 25. For example, FIG. 10 depicts a plan view of a cutter 20 according to an embodiment of the invention. The cutter 20 comprises a blade 10 that forms a substantially closed shape. The shape is substantially closed because there is only a single relatively small gap 25.

FIGS. 11 and 12 each depict a plan view of a cutter 20 according to the present invention. The cutter 20 depicted in FIG. 11 comprises two blades 10. Each blade 10 forms an L-shape, which is a shape that is not closed. The cutter 20 comprises two gaps 25 between the blades 10. The cutter 20 forms a rectangular shape, which is substantially closed because the gaps are small. In an embodiment the blades 10 may contact each other such that there is no gap 25.

The cutter 20 depicted in FIG. 12 comprises four blades 10. Each blade 10 forms a straight line, which is not a shape. The cutter 20 forms a rectangular shape, which is substantially closed because the gaps are small. In an embodiment the blades 10 may contact each other such that there is no gap 25.

In the following description, an embodiment in which the cutter 20 comprises a single blade 10 is described. However, it will be understood that the cutter 20 may comprise more than one blade 10, as set out above.

In a cutting operation, the blade 10 is brought into contact with a surface 15 to be cut. As the blade 10 approaches the surface 15, the first teeth 11 come into contact with the surface 15 before the second teeth 12. When the first teeth 11 come into contact with the surface 15, the first teeth 11 apply pressure to the points of contact between the first teeth 11 and the surface 15. When the second teeth 12 come into contact with the surface 15, the second teeth apply pressure to the surface at the points of contact between the second teeth 12 and the surface 15. However, the pressure applied by the first teeth 11 is greater than the pressure applied by the second teeth 12 because the first teeth 11 are longer than the second teeth 12.

As a result, the pressure along the cutting perimeter is non-uniform. The elongating stress to the surface 15 is reduced compared to a case in which uniform pressure is applied along the cutting perimeter, as with a standard serrated blade or a non-serrated blade. For example, uniform pressure can be applied along the cutting perimeter if a serrated blade is used in which all of the teeth have substantially the same length.

When the pressure applied by the first teeth 11 on the surface is sufficiently great, the first teeth 11 start penetrating the surface 15. Subsequently, the second teeth 12 penetrate the surface 15. The cut along the cutting perimeter of the surface is completed as the blade 10 continues to move through the surface 15. Accordingly, the present invention provides a serrated blade 10 that can cut through a surface 15 to be cut in an efficient way.

In particular, the present invention provides a blade 10 that addresses the problem of the surface 15 stretching during the cutting operation. If the surface 15 stretches, then the surface 15 may not be completely cut, or the blade 10 may be required to move a greater distance beyond the starting line of the surface 15 (i.e. through the surface 15) so as to complete the cut.

This problem can be particularly acute for die cutting operations. A die cutting operation is a cutting operation in which a blade that forms a closed shape cuts a surface 15 to be cut. A die cutting operation is contrasted with a straight cutting operation. In a straight cutting operation, a straight line is cut in a surface to be cut by a blade. In a straight cutting operation, stretching of the surface during the cutting operation can be effectively reduced by applying tension to the surface during the cutting operation. For example, if the surface to be cut is a type of plastic film, then the plastic film can be stretched out before the blade comes into contact with the plastic film. In this way, the plastic film stretches by a reduced amount during the straight cutting operation.

However, in a die cutting operation, it is significantly more difficult to reduce the stretching of the plastic film by applying tension to the plastic film before the cutting takes place. Hence, the factors involved in making clean cuts in straight cutting operations are different from the factors involved in making clean cuts in die cutting operations.

In an embodiment the first teeth 11 are interspersed with second teeth 12 of the plurality of second teeth 12. Accordingly, it is possible to avoid applying uniform pressure along the cutting perimeter of the surface 15 to be cut. This reduces elongation of the surface 15 to be cut which would otherwise hinder the cutting process.

The serrated blade 10 may comprise at least as many second teeth 12 as first teeth 11. In this case, at least one second tooth 12 may be disposed between each pair of adjacent first teeth 11. In an embodiment, the serrated blade 10 may comprise at least as many first teeth 11 as second teeth 12. In this case, there may be at least one first tooth 11 disposed between each pair of adjacent second teeth 12. In an embodiment, the blade 10 comprises a substantially equal number of first teeth 11 as second teeth 12. In this case, the first teeth 11 and second teeth 12 may be arranged alternately along the blade 10.

In an embodiment the first teeth 11 are longer than the second teeth 12 by a distance within the range of from about 0.5 mm to about 1.0 mm. Accordingly, the difference in teeth length is sufficiently great that the pressure applied along the cutting perimeter is sufficiently non-uniform so as to reduce undesirable stretching of the surface 15 to be cut during the cutting operation.

Furthermore, the difference in length between the teeth is sufficiently small that the blade 10 is required to move a relatively small distance relative to the surface 15 to be cut in order to perform the cutting operation. This improves the cleanness of the cut, thereby improving its aesthetic appearance. If the difference in teeth length were large, then the blade would have to move a large distance in order for the second teeth to come into contact with the partially-stretched film to perform the cutting.

In an embodiment the first teeth 11 have a length of at least 3 mm. In an embodiment the first teeth 11 have a length of at most 4 mm. In an embodiment the first teeth 11 have a length of about 4 mm. In an embodiment all of the first teeth 11 have substantially the same length as each other such that in use all of the first teeth 11 contact a surface 15 to be cut at substantially the same time. However, there may be slight variations between the lengths of the first teeth 11 within manufacturing tolerances.

In an embodiment a plurality of the plurality of second teeth 12 have a length of at least 2 mm, optionally at least 2.5 mm and optionally at least 3 mm. In an embodiment a plurality of the plurality of second teeth 12 have a length of at most 3.5 mm and optionally at most 3 mm. In an embodiment a plurality of the plurality of second teeth 12 have a length of about 3 mm.

In an embodiment all of the second teeth 12 have substantially the same length as each other such that in use all of the second teeth 12 contact a surface 15 to be cut at substantially the same time. However, there may be slight variations between the lengths of the second teeth 12 within manufacturing tolerances. Furthermore, as explained below, the second teeth 12 may comprise a plurality of sets of teeth having different lengths.

In an embodiment the first teeth 11 are longer than the second teeth 12 by a distance of at least 0.5 mm and optionally at least 0.7 mm. The larger the difference in length between the first teeth 11 and the second teeth 12, the less uniform the pressure that is applied along the cutting perimeter. This helps to cut through thin and stretchable materials particularly.

In an embodiment the first teeth 11 are longer than the second teeth 12 by a distance of at most 1 mm. The greater the difference in length between the first teeth 11 and the second teeth 12 the further the blade 10 has to be move relative to the surface 15 to be cut in order to perform the cutting operation. Even with a long distance travelled by the blade 12 relative to the surface 15 to be cut, the cutting operation can be completed. However, the greater the distance travelled, the aesthetic appearance of the cut can be reduced. This is because the surface 15 may stretch during the cutting operation such that after the cut has been completed, the surface 15 remains stretched undesirably.

In an embodiment the first teeth 11 are longer than the second teeth 12 by a distance of about 1 mm.

In an embodiment a ratio of a length of the first teeth 11 to the length of the second teeth 12 is at least 8:7 (or about 1.15 expressed fractionally). In an embodiment the ratio of the length of first teeth 11 to the length of the second teeth 12 is at most 3:2 (or about 1.50 expressed fractionally). In an embodiment the ratio of the length of the first teeth 11 to the length of the second teeth 12 is about 4:3 (or about 1.35 expressed fractionally). Here, the fractions are expressed to the nearest 0.05.

If the ratio is too great, then there is a possibility that the first teeth 11 are so far apart from each other that the surface 15 to be cut merely bends when contacted by the first teeth 11 but is not cut. This undesirable effect can be overcome by providing first teeth 11 having a very narrow angle A1 at their tip so that they can be arranged closer together. However, this makes the first teeth 11 more susceptible to breakage.

Additionally, if the ratio is too great, then the first teeth 11 may have penetrated the surface 15 such that they no longer apply pressure to the surface 15 when the second teeth 12 come into contact with the surface 12. In this case, the effect of applying non-uniform pressure along the surface 15 is reduced.

As depicted in FIG. 1, the length of each tooth is measured from the tip of the tooth to the root of the tooth. The length is measured in the direction in which the blade moves so as to perform the cutting operation. As shown in FIG. 1, this is the Y-direction. The root of the tooth is the position at which the tooth joins the base portion of the blade 10. The base portion of the blade is substantially solid and rectangular and is not serrated. The root of the tooth is level with the points 21 at which pairs of adjacent teeth separate from each other at a gap in the blade 10 in the X-direction as shown in FIG. 1.

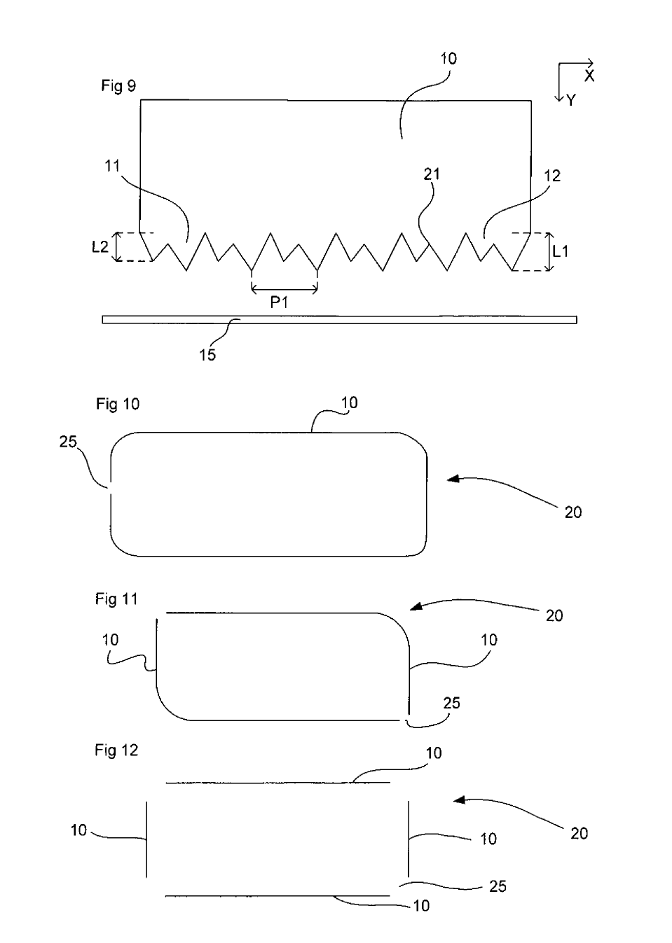

In FIG. 1, reference numeral 21 refers to a point at which two adjacent teeth are separated from each other. The length of each tooth is measured from point 21 to the tip of the tooth in the Y-direction. As depicted in FIG. 1, in an embodiment substantially all of the first teeth 11 and substantially all of the second teeth 12 are positioned between gaps in the X-direction that start at the same point 21 in the Y-direction. That is, all of the points 21 are at the same position in the Y-direction. However, this need not be the case. For example, the gaps that form the teeth may start at different points along the Y-direction. FIG. 9 depicts such a structure.

In an embodiment the first teeth 11 are arranged along the blade 10 at an average interval P1 within the range of from about 5 mm to about 10 mm. Accordingly, the distance between the first teeth 11 is sufficiently great so as to reduce the pressure applied on the surface 15 to be cut. This reduces the stretching of the surface 15 during the cutting operation. The distance between the first teeth is sufficiently small such that the first teeth 11 can penetrate the surface 15 to be cut so as to perform the cutting operation effectively.

In FIG. 1, the interval at which the first teeth 11 are arranged is denoted by reference numeral P1. In an embodiment the first teeth 11 are arranged along the blade at an average interval P1 of at least 5 mm, optionally at least 7 mm and optionally at least 9 mm. In an embodiment the first teeth 11 are arranged along the blade at an average interval P1 of at most 10 mm, and optionally at most 7 mm. In an embodiment the first teeth 11 are arranged along the blade at an average interval P1 of about 6.5 mm.

In an embodiment the first teeth 11 and/or second teeth 12 are arranged along the blade at substantially regular intervals. However, the intervals need not be perfectly regular. For example, there may be slight variations between intervals within manufacturing tolerances. Furthermore, the intervals may be irregular. In this case, the intervals may correspond to a repeating pattern, or may be substantially random.

In an embodiment the blade 10 comprises a substantially equal number of first teeth 11 and second teeth 12. For example, FIG. 1 depicts an embodiment in which the blade 10 comprises a substantially equal number of first teeth 11 and second teeth 12. However, this need not be the case. In an embodiment the blade 10 comprises about two times the number of second teeth 12 as first teeth 11.

In an embodiment the blade 10 comprises about three times the number of second teeth 12 as first teeth 11. FIG. 3 depicts such an embodiment. As depicted in FIG. 3, second teeth 12 are disposed along the blade 10 between each pair of adjacent first teeth 11. The ratio of first teeth to second teeth is not particularly limited. Accordingly, the ratio of first teeth 11 to second teeth 12 can be chosen so as to minimize stretching of a film to be cut during a cutting operation.

In an embodiment the plurality of second teeth 12 comprises at least two sets of teeth that have different lengths such that in use the two sets of teeth contact a surface 15 to be cut at different times. FIG. 3 depicts such an embodiment in which the plurality of second teeth 12 comprises two sets of teeth having different lengths. Accordingly, the blade 10 comprises teeth 11, 12 of three different lengths. Accordingly, during a cutting operation the first teeth 11 contact the surface 15 to be cut first. The first teeth 11 start penetrating the surface 15. Then, on a second step, the longer of the two sets of second teeth 12 continue the cutting of the surface 15. Then, on a third step, the shorter of the two sets of second teeth 12 complete the cutting of the surface 15 in an efficient way.

The distance between the teeth of the longer set of second teeth 12 can be chosen so as to minimize pressure on the surface 15 to be cut during the second step of the cutting operation. This helps to reduce the stretching of the surface 15 during the cutting operation. In turn, this improves the quality of the cut.

As depicted in FIG. 3, in an embodiment the blade 10 comprises about two times the number of the longer set of second teeth 12 as the shorter set of the second teeth 12. There may be at least one of the shorter teeth of second teeth 12 disposed between each adjacent pair of the longer set of second teeth 12. Each first tooth 11 may be positioned between a pair of the longer set of second teeth 12.

In an embodiment each of the first teeth 11 forms a sharp point at its tip. The tip may have an angle A1, in the plane of the blade 10, within the range of from about 50° to about 60°. In an embodiment each of the second teeth 12 forms a sharp point at its tip having an angle A2, in the plane of the blade 10, within the range of from about 50° to about 60°.

Accordingly, the angle is sufficiently small that the teeth 11, 12 can penetrate the surface 15 to be cut while reducing the undesirable stretching of the surface 15 during the cutting operation. Furthermore, the angle is sufficiently great the first teeth 11 can, during the penetration of the surface 15, create a slit that is sufficiently long as to aid the completion of the cutting operation during the second and optionally third cutting steps. Additionally, the first teeth 11 continue to apply pressure on the surface 15 to be cut when the second teeth 12 come into contact with the surface 15.

The tip angle A1 of the first teeth 11 and the tip angle A2 of the second teeth 12 may be substantially equal to each other. However, this need not be the case. In an embodiment, the tip angle A1 of the first teeth 11 may be about 50°. The tip angle A2 of the second teeth 12 may be about 50°, or may be a different angle such as 55° or 60°.

In an embodiment each of the first teeth 11 and/or each of the second teeth 12 forms a substantially triangular shape. The triangular shape provides a sharp tip. However, other shapes of teeth are possible and the shape is not particularly limited. The teeth 11, 12 need not have a sharp tip. For example, other shapes of teeth that are possible are a rectangle or a semi-circle.

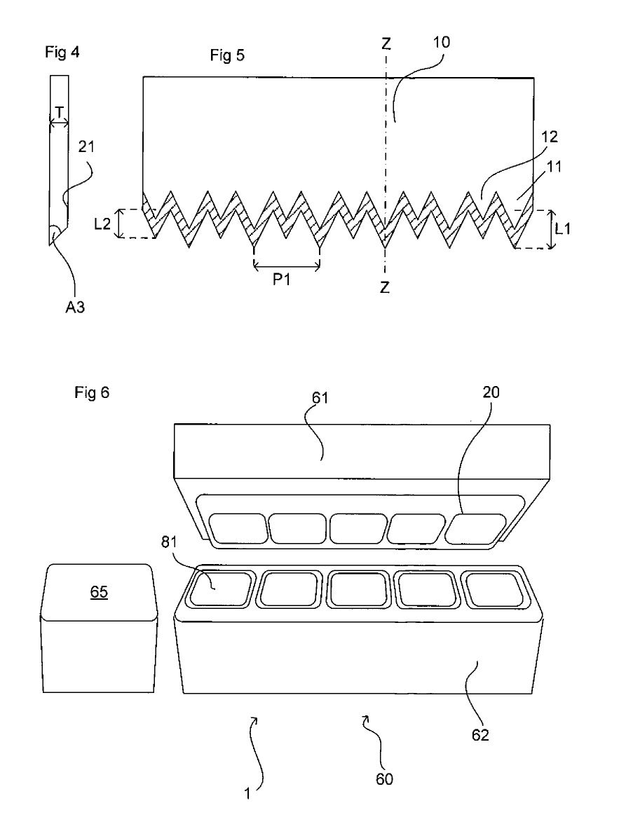

FIG. 4 depicts a cross-section of the blade 10 across the thickness of the blade. The X-direction of FIG. 1 corresponds to the direction into and out of the page in FIG. 4. In an embodiment the thickness T of the blade tapers towards the tips of the first teeth 11 and/or towards the tips of the second teeth 12. Accordingly, the sharpness of the blade can be improved. The blade 10 may have sharp singular points at which it comes into contact with a surface 15 to be cut. This helps penetration of the surface 15 by the blade 10.

In an embodiment, the tapering angle A3 is at least about 10°, and optionally at least about 15°. In an embodiment the tapering angle A3 is at most about 30°, and optionally at most about 20°. In an embodiment the tapering angle A3 is about 17°.

Accordingly, the tapering angle A3 is sufficiently low so that the blade 10 of the cutter 20 is sharp, thereby penetrating the surface 15 more easily. Furthermore, the tapering angle A3 is sufficiently high so that the blade 10 is durable. If the tapering angle A3 is to low, then the tip of the blade 10 becomes more easily broken. This is particularly a danger because the blade 10 may come into contact with the tray 81 during a cutting operation, the tray 81 being harder than the film 82.

In an embodiment the thickness T of the blade is in the range of from about 0.8 mm to about 2 mm, and preferably about 1.0 mm. Here, the thickness T of the blade is measured in the base portion of the blade 10, and not in the tapering portion of the blade 10.

FIG. 5 depicts a blade according to an embodiment of the invention. FIG. 4 and FIG. 5 may depict the same blade 10 viewed from different angles. The hatched section of the blade 10 depicted in FIG. 5 corresponds to the tapered portion of the blade 10. FIG. 4 is a cross-section taken along line Z in FIG. 5.

According to the present invention, there is provided a packaging apparatus 1 comprising the cutter 20 according to an embodiment of the invention. Accordingly, the blade 10 can be used to perform clean cuts in packaging processes.

In an embodiment, the packaging apparatus 1 comprises an actuator 71. The actuator 71 is configured to move the blade 10 in a cutting operation. The packaging apparatus 1 is configured such that the actuator 71 moves the blade 10 by a maximum distance within the range of from about 5 mm to about 15 mm.

Accordingly, the blade 10 may be moved by a sufficient distance so as to perform a complete cut of the surface 15 to be cut. Furthermore, the movement of the blade 10 relative to the surface 15 to be cut is limited such that the aesthetic appearance of the completed cut is improved. In particular, if a large relative movement between the blade 10 and the surface 15 occurs, then the cut may have an undesirable appearance.

In an embodiment, the packaging apparatus is configured such that the actuator 71 moves the blade 10 by a maximum distance of at least 5 mm. In an embodiment, the packaging apparatus 1 is configured such that the actuator 71 moves the blade 10 by a maximum distance of at most 15 mm. The actuator 71 may comprise a motor to drive the blade 10 during a cutting operation. However, the type of actuator 71 is not particularly limited.

In an embodiment the packaging apparatus 1 comprises a sealer 72. The sealer 72 may be a heat sealer. The sealer 72 is configured to seal a film to a tray. Accordingly, the blade 10 can be used in the context of a packaging apparatus 1 that applies film lids to trays. The trays may be used to package food.

The tray 81 may be formed of a foam material, or may be formed from a solid plastic sheet, for example. The film 82 is sealable, preferably heat sealable. In an embodiment, the film 82 comprises a heat sealable polyolefin, preferably a polyethylene material.

The packaging apparatus 1 may comprise a tray lidding machine 60, as depicted in FIG. 6, for example. In an embodiment the tray lidding machine 60 comprises a support section 62 and a cut/seal section 61.

The support section 62 is configured to support at least one tray 81. The support section 62 may support three or five trays 81, for example, the exact number not being particularly limited. The support section 62 comprises compartments configured to hold and position the tray 81 in a predefined position.

The cut/seal section comprises the blade 10 and a sealer 72. A film 82 is suspended above the tray 81. During a tray lidding operation, the cut/seal section 61 is brought together with the support section 62. The blade 10 and sealer 72 cut and seal, respectively, the film 82 to the tray 81 to form a lid.

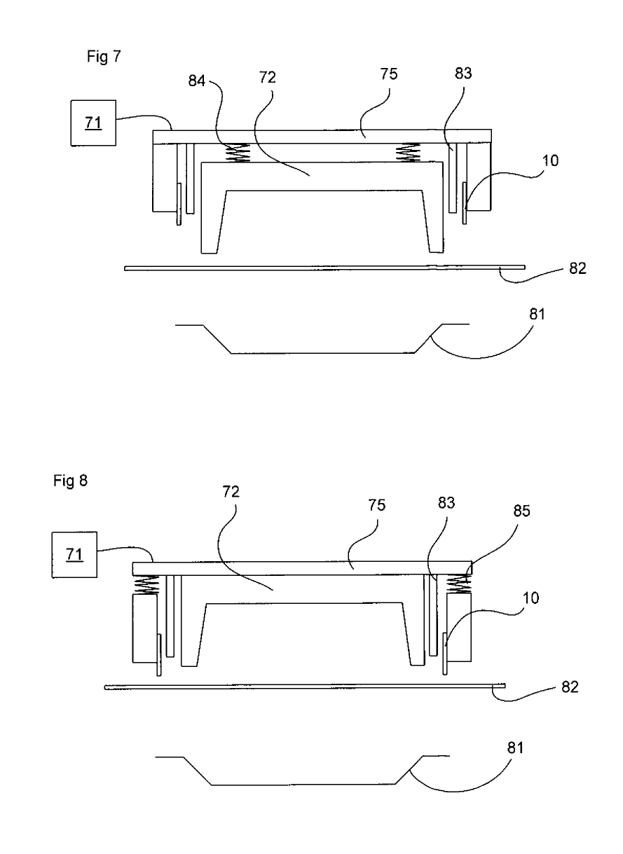

FIG. 7 depicts a part of a packaging apparatus 1 according to an embodiment of the invention. An exemplary operation of the apparatus depicted in FIG. 7 is set out below.

The film 82 is suspended above the tray 81. An actuator actuates the sealer 72 such that the sealer 72 presses the film 82 onto the tray 81. Accordingly, the film 82 forms the lid of the packaging that is to be formed.

The actuator 71 moves the blade 10 so as to cut the film 81. The blade 10 is configured to cut the film 82 so as to form the desired shape of the lid of the food packaging.

For example, as depicted in FIG. 2, the blade 10 may form a rectangular shape. The rectangular shape may optionally have rounded corners. In an embodiment the blade has a width TW, in plan view, within the range of from about 10 cm to about 50 cm. In an embodiment the blade has a length TL, in plan view, within the range of from about 15 cm to about 75 cm.

However, other shapes are also possible, depending on the desired shape of the lid. In particular, the blade may form a circular or oval shape. The lid may have substantially the same shape as the tray 81. Hence, the blade 10 can be designed to form a shape that matches the shape of the tray 81.

The actuator 71 that actuates the sealer 72 may be the same as the actuator that actuates the blade 10. However, this need not be the case. For example, a separate actuator may be used to move each of the sealer 72 and the blade 10.

The film 82 may be sealed to the tray 81 either before or after the film 82 is cut by the blade 10. As depicted in FIG. 7, in an embodiment the film 82 is sealed to the tray 81 before the film 82 is cut by the blade 10. As depicted in FIG. 8, in an embodiment the film is cut by the blade 10 before the film 82 is sealed to the tray 81 by the sealer 72.

The sealer 72 may be configured to seal the film 82 to the tray 81 by heating the film 82 to the tray 81. In an embodiment a sealer 72 is configured to heat to a temperature within the range of from about 100° Celsius to about 220° Celsius so as to seal the film 82 to the tray 81. Accordingly, the blade 10 can be used to efficiently cut a film 82 that has undergone heating. This is significant because when a film 82 is heated, it can before even more stretchable than normal. As such, a heated film 82 is more susceptible to undergo undesirable elongation and/or stretching during a cutting operation. Hence, a heated film 82 can be more difficult to cut than a non-heated film. The blade 10 of the present invention has been found to be able to cut thin and stretchable films even after they have undergone heating.

In an embodiment, the packaging apparatus 1 comprises at least one insulating plate 83 configured to insulate the blade 10 from the sealer 72. The insulating plate 83 reduces the heat energy absorbed by the blade 10, thereby reducing the temperature of the blade 10 in operation. This reduces the heating effect of the film 82 during the cutting operation by the blade 10.

However, even with an insulating plate 83, the blade 10 may reach a temperature within the range of about 60° Celsius to about 170° Celsius. In an embodiment, the blade 10 is formed from a metal. The blade 10 is formed from a metal that can withstand a temperature of at least 100° Celsius. The metal may be stainless steel, for example. Other types of metal may also be suitable.

In an embodiment the sealer 72 comprises a shape that corresponds substantially to the shape of the outline of the tray 81. Hence, as the sealer 72 presses the film 82 against the tray 81, the sealer 72 seals the film 81 to the border of the frame of the tray 81.

As depicted in FIG. 7, in an embodiment the sealer 72 is attached to a frame 75 of the packaging apparatus 1 by at least one spring 84. When the sealer 72 presses the film 82 against the tray 81, the at least one spring 84 compresses. Subsequently the blade 10, which may be connected either directly or indirectly to the same frame 75 as the sealer 72, comes into contact with the film 82 sealed on the tray 81. The blade 10 cuts the film 82.

Alternatively, as depicted in FIG. 8, in an embodiment the blade 10 is connected to a frame 75 of the packaging apparatus 1 either indirectly or directly by at least one spring 85. When the blade 10 and the tray 81 move towards each other, the blade 10 presses the film 82 against the tray 81 and cuts the film 82. Subsequently, the tray 81 prevents further movement of the blade 10 and the at least one spring 85 compresses. Subsequently, the sealer 72 presses the cut film 82 against the tray 81 and seals it.

Alternatively, the seal and cut steps described for FIGS. 7 and 8 above may be performed by raising the support section 62 rather then by lowering the cut/seal section 61 of the packaging apparatus 1 or by a combination of both the movements.

During the cutting operation, the blade 10 may come into contact with the tray 81 itself. Hence, the blade 10 should be durable so as to maintain structural integrity during contact with the tray 81. The first teeth 11 penetrate the film 82 before the film 82 is completely cut through. It is possible that the first teeth 11 begin to cut through the tray 81 during the cutting operation.

The blade 10 of the present invention is particularly advantageous when used to cut thin and stretchable film 82. This may be the case when the blade 10 is used, for example, in the context of a tray lidding machine 60.

In an embodiment the packaging apparatus 1 comprises a film dispenser 65 configured to dispense film 82. The film dispenser 65 may be configured to dispense film 82 that has a thickness of less than about 30 μm, optionally less than about 25 μm, optionally less than about 20 μm, and optionally about 15 μm or less.

In an embodiment the film 82 has a Young's modulus of less than about 100,000 MPa. The packaging apparatus 1 is configured such that the serrated blade 10 cuts the film 82. Accordingly, the blade 10 of the present invention can be used to efficiently cut through a film 82 that is thin and/or stretchable.

In an embodiment the film 82 has a Young's modulus of less than about 60,000 MPa, optionally less than about 50,000 MPa and optionally less than about 30,000 MPa. In an embodiment the film has an elastic modulus of about 60,000 MPa, about 50,000 MPa, or about 25,000 MPa. The elastic modulus is measured at a temperature of 23° C. using standard techniques (ASTM D-883).

In an embodiment the film 82 may have an elongation of at least 60%, and optionally at least 80%. The elongation corresponds to the strain of the material (expressed as a percentage of the starting length) when a force is applied to a length of the material at the time when the material breaks (ASTM D-882).

In an embodiment the film 82 comprises a material that has a tensile strength of less than about 11,000 MPa, optionally less than about 9,000 MPa, and optionally about 8,500 MPa (ASTM D-882).

Exemplary materials that may be used to form the film 82 and their associated properties are set out below in Table 1.

TABLE 1

| Material | Sample A | Sample B | Sample C |
|---|---|---|---|
| Thickness/μm | 25 | 21 | 15 |
| Elongation/% | 60-80 | 80-100 | 70 |
| Elastic Modulus at | 56 | 41-46 | 23-24 |
| 23° C./GPa | | | |
| Tensile Strength/MPa | 8.5 | 7.0-9.0 | 9.0-10.5 |

Sample A is a polyethylene based barrier film that comprises polyamide, described in EP236099. The polyamide gives stiffness to the film. Sample B, described in WO2011029950, and Sample C, described in US5942326, are polyethylene based materials. The Sample B is known to be particularly soft. The Sample C material is known to be particularly stretchable.

Using the blade 10 according to an embodiment of the present invention, a film 82 comprising any of these exemplary materials can be cut, providing a clean cut. The tests were performed using the tray lidding machine Mondini 380 in the context of sealing lids onto foam trays. The blade 10 of the present invention can cut these films 82 which are thin and stretchable even when the film 82 is sealed by heat to the tray 81 prior to the blade 10 cutting through the film. A cut that has a pleasing aesthetic appearance can be achieved.

1. A cutter for a packaging apparatus, the cutter forming a shape and comprising at least one blade, each blade comprising:
a plurality of first teeth; and
a plurality of second teeth;
wherein the first teeth are longer than the second teeth such that in use the first teeth contact a surface to be cut before the second teeth.

2. The cutter of claim 1, wherein the first teeth are interspersed with second teeth of the plurality of second teeth.

3. The cutter of claim 1, wherein the cutter forms a substantially closed shape.

4. The cutter of claim 1, wherein the first teeth are longer than the second teeth by a factor within the range of from about 1.15 to about 1.50.

5. The cutter of claim 1, wherein:
the at least one blade comprises a substantially equal number of first teeth and second teeth; or
the at least one blade comprises about three times the number of second teeth as first teeth.

6. The cutter of claim 1, wherein the plurality of second teeth comprises at least two sets of teeth that have different lengths such that in use the two sets of teeth contact a surface to be cut at different times.

7. The cutter of claim 1, wherein each of the first teeth and/or each of the second teeth forms a sharp point at a tip having an angle, in a plane of the blade, within the range of from about 50 degrees to about 60 degrees.

8. The cutter of claim 1, wherein the thickness of the at least one blade tapers towards the tips of the first teeth and/or towards the tips of the second teeth.

9. A packaging apparatus comprising the cutter of claim 1.

10. The packaging apparatus of claim 9, further comprising an actuator configured to move the cutter in a cutting operation, wherein the packaging apparatus is configured such that the actuator moves the cutter by a maximum distance within the range of from about 5 mm to about 15 mm.

11. The packaging apparatus of claim 9, further comprising a sealer configured to seal a film to a tray, wherein optionally the packaging apparatus is configured such that in a packaging operation, the film is sealed to the tray before the film is cut by the cutter.

12. The packaging apparatus of claim 11, wherein the sealer is configured to heat to a temperature within the range of from about 100 degrees Celsius to about 220 degrees Celsius so as to seal the film to the tray.

13. The packaging apparatus of claim 9, further comprising a film dispenser configured to dispense film that has a thickness of less than about 30 micrometers and/or a Young's modulus of less than about 100,000 MPa, wherein the packaging apparatus is configured such that the cutter cuts the film.

14. A method of cutting a film comprising the steps of:
providing a cutter forming a shape and comprising at least one blade, each blade comprising a plurality of first teeth and a plurality of second teeth, wherein the first teeth are longer than the second teeth; and
cutting the film with the cutter such that the first teeth contact the film before the second teeth.

15. The method of claim 14, wherein the second teeth start penetrating the film before the film is completely cut.
